(19) United States
(12) Patent Application Publication
(10) Pub. No.: US 2009/0116186 A1
(43) Pub. Date: May 7, 2009

(54) Cooling unit and electronic apparatus

(75) Inventors: Jie Wei, Kawasaki (JP); Keizou Takemura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/318,628

(22) Filed: Jan. 2, 2009

Related U.S. Application Data
(63) Continuation of application No. PCT/JP06/13319, filed on Jul. 4, 2006.

(51) Int. Cl. G06F 1/16; F28F 7/00

(52) U.S. Cl. 361/690; 165/80.3

(57) ABSTRACT

According to an aspect of an embodiment, a cooling unit includes a first heat dissipating fin member including first heat dissipating fins extending along parallel planes, respectively, the first heat dissipating fins coupled to one another through a first heat conductive member, and a second heat dissipating fin member including second heat dissipating fins extending along parallel planes, respectively, the second heat dissipating fins coupled to one another through a second heat conductive member, the tip ends of the second heat dissipating fins opposed to the first heat dissipating fin member at a predetermined interval.

### CROSS-REFERENCE TO RELATED APPLICATION

This application is a continuing application, filed under 35 U.S.C. §111(a), of International Application PCT/JP2006/313319, filed Jul. 4, 2006, the contents of which are incorporated herein by reference.

### BACKGROUND

1. Field

The present invention relates to a cooling unit incorporated in an electronic apparatus such as a display apparatus, for example.

2. Description of the Prior Art

A heat sink is incorporated in the enclosure of a display apparatus, for example. The heat sink includes a heat receiving plate receiving an electronic component and heat dissipating fins standing upright from the heat receiving plate. Heat is transferred from the electronic component to the heat dissipating fins through the heat receiving plate. The heat is dissipated into the air from the heat dissipating fins. Since temperature is different between atmosphere around the heat dissipating fins and the outside of the enclosure, a natural convection of air is caused through an air inlet of the enclosure into the inner space of the enclosure. The heat is discharged out of the enclosure through an air outlet of the enclosure based on the natural convection.

In general, the rate of heat dissipation is considerably small per unit area in the heat dissipating fins. It is required to increase the surface area of the heat dissipating fins for improvement of the rate of heat dissipation. The size of the heat dissipating fins increases so as to ensure the large surface area. The size of the display apparatus inevitably increases. An increase in the size of the heat dissipating fins results in an increase in heat resistance in the heat dissipating fins. The heat sink suffers from deterioration of efficiency of heat dissipation.

### SUMMARY

According to an aspect of an embodiment, a cooling unit comprises: a first heat dissipating fin member including first heat dissipating fins extending along parallel planes, respectively, the first heat dissipating fins coupled to one another through a first heat conductive member; and a second heat dissipating fin member including second heat dissipating fins extending along parallel planes, respectively, the second heat dissipating fins coupled to one another through a second heat conductive member, the tip ends of the second heat dissipating fins opposed to the first heat dissipating fin member at a predetermined interval.

The objects and advantages of the invention will be realized and attained by means of the elements and combinations particularly pointed out in the claims. It is to be understood that both the foregoing general description and the following detailed description are exemplary and explanatory only and are not restrictive of the invention, as claimed.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a perspective view schematically illustrating a server computer apparatus as a specific example of an electronic apparatus according to the present invention;

FIG. 2 is a partial sectional view schematically illustrating a part of the server computer apparatus;

FIG. 3 is a perspective view schematically illustrating a cooling unit according to an embodiment of the present invention;

FIG. 4 is a view schematically illustrating a coolant flow passage within a heat transfer plate;

FIG. 5A is a perspective view schematically illustrating an analysis model of a cooling unit according to the present invention;

FIG. 5B is a perspective views schematically illustrating a cooling unit according to a comparative example;

FIG. 6 is a perspective view schematically illustrating a cooling unit according to another specific example of the present invention;

FIG. 7 is a perspective view schematically illustrating a cooling unit according to another specific example of the present invention;

FIG. 8 is a side view schematically illustrating the structure of the cooling unit;

FIG. 9 is a view schematically illustrating a cooling unit according to another specific example of the present invention; and

FIG. 10 is a view schematically illustrating a cooling unit according to another specific example of the present invention

### DESCRIPTION OF THE PREFERRED EMBODIMENT

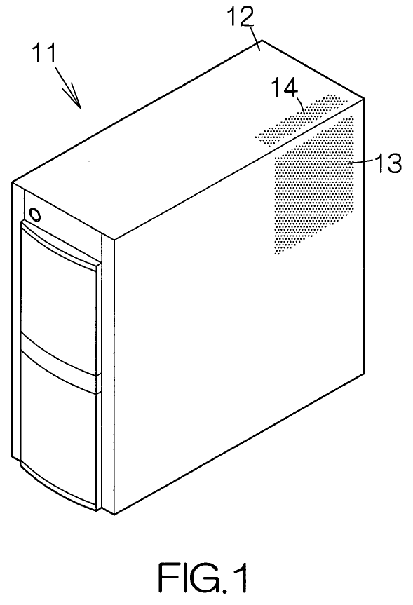

FIG. 1 schematically illustrates a server computer apparatus 11 as a specific example of an electronic apparatus according to the present invention. A server computer apparatus 11 includes an enclosure 12. The enclosure 12 defines an inner space. A motherboard is placed within the inner space, for example. The motherboard includes a CPU (central processing unit) chip. The CPU chip is designed to execute various kinds of processing based on an operating system (OS) and/or application software, for example. A keyboard and a display apparatus, both not shown, may be connected to the server computer apparatus 11, for example.

The enclosure 12 includes the side wall extending along a vertical imaginary plane. An air inlet 13 is defined in the side wall of the enclosure 12. Fresh air is introduced into the enclosure 12 through the air inlet 13. The enclosure 12 also includes the top plate extending along a horizontal imaginary plane at the top of the enclosure 12. An air outlet 14 is defined in the top plate of the enclosure 12. The introduced air is discharged out of the enclosure 12 through the air outlet 14. The air inlet 13 and the air outlet 14 each may include a number of through holes, for example.

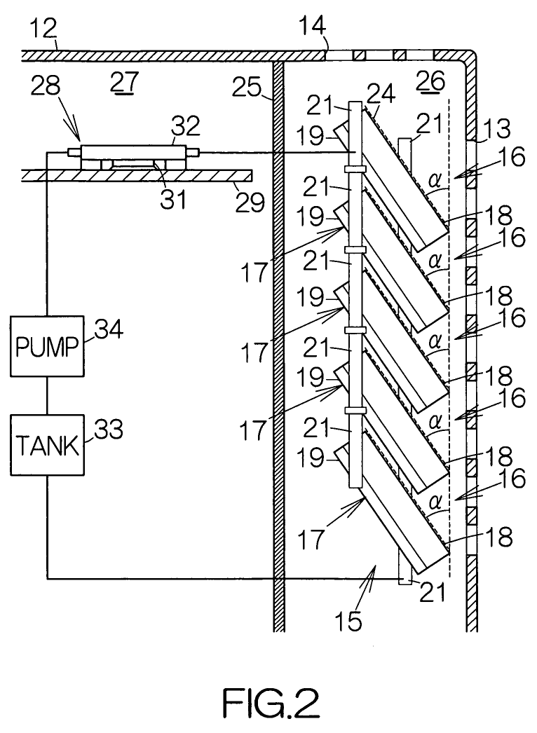

As shown in FIG. 2, a cooling unit 15 is incorporated in the enclosure 12. The cooling unit 15 includes five heat sinks 16, for example. The heat sinks 16 are arranged in the vertical direction along the side wall of the enclosure 12. The front side of the cooling unit 15 is opposed to the air inlet 13. The air outlet 14 is defined above the cooling unit 15.

The individual heat sink 16 includes a heat dissipating fin member 17. The heat dissipating fin member 17 includes heat dissipating fins 18 extending along parallel planes, respectively. Here, the heat dissipating fins 18 extend in parallel from one another. The heat dissipating fin member 17 also includes a heat conductive member, namely a heat transfer plate 19, coupling the heat dissipating fins 18 to one another. The heat dissipating fins 18 stand upright from the front surface of the heat transfer plate 19. The individual heat dissipating fin 18 may be made out of a flat plate, for example. An air passage is defined between adjacent ones of the heat dissipating fins 18. A coolant flow passage is defined within the heat transfer plate 19. The heat dissipating fins 18 and the heat transfer plate 19 may be made of a metallic material such as aluminum, for example.

The individual heat sink 16 includes coupling members, namely first and second coupling pipes 21, 21, connected to the opposite ends of the heat transfer plate 19, respectively. The individual coupling pipe 21 defines a coolant flow passage. The first and second coupling pipes 21, 21 extend along parallel imaginary lines, respectively. Here, the first and second coupling pipes 21, 21 extend in parallel with each other on the heat transfer plate 19. The first and second coupling pipes 21 serve to removably couple the heat sinks 16 to one another. The lower ends of the first and second coupling pipes 21 of the individual heat sink 16 are connected to the upper ends of the first and second coupling pipes 21 of the heat sink 16 located below the former one, respectively.

The tip ends of the heat dissipating fins 18 are opposed to the back surface of the heat transfer plate 19 of the heat sink 16 located right above at a predetermined interval. The tip ends of the heat dissipating fins 18 are arranged along an imaginary inclined plane intersecting the vertical plane by a predetermined angle α. The tip end of the individual heat dissipating fin 18 and the back surface of the heat transfer plate 19 may be distanced from each other at a constant interval.

A heat insulating member, namely a heat insulating board 25, is located in the enclosure 12. The heat insulating board 25 may extend along a plane parallel to the side wall of the enclosure 12, for example. Here, the heat insulating board 25 extends in parallel with the side wall of the enclosure 12. The heat insulating board 25 partitions a first space 26 off a second space 27 in the enclosure 12. The cooling unit 15 is located in the first space 26. The aforementioned motherboard 28 is located in the second space 27. The heat insulating board 25 serves to prevent exchange of airflow between the first and second spaces 26, 27. The motherboard 28 is in this manner prevented from receiving heat from the cooling unit 15.

The motherboard 28 includes an electronic component, namely the aforementioned CPU chip 31, mounted on the surface of a printed wiring board 29. A heat receiving plate 32 is received on the CPU chip 31 in close contact with the top surface of the CPU chip 31. A coolant flow passage is defined in the heat receiving plate 32. The cooling unit 15 is connected to the heat receiving plate 32 at a position downstream of the heat receiving plate 32. A tank 33 is connected to the cooling unit 15 at a position downstream of the cooling unit 15. A pump 34 is connected to the tank 33 at a position downstream of the tank 33. The heat receiving plate 32 is connected to the pump 34 at a position downstream of the pump 34. A closed circulating loop for coolant is in this manner established. The pump 34 allows a coolant to flow in the closed circulating loop. The cooling unit 15, the heat receiving plate 32, the tank 33 and the pump 34 in combination serve to establish a liquid cooling unit.

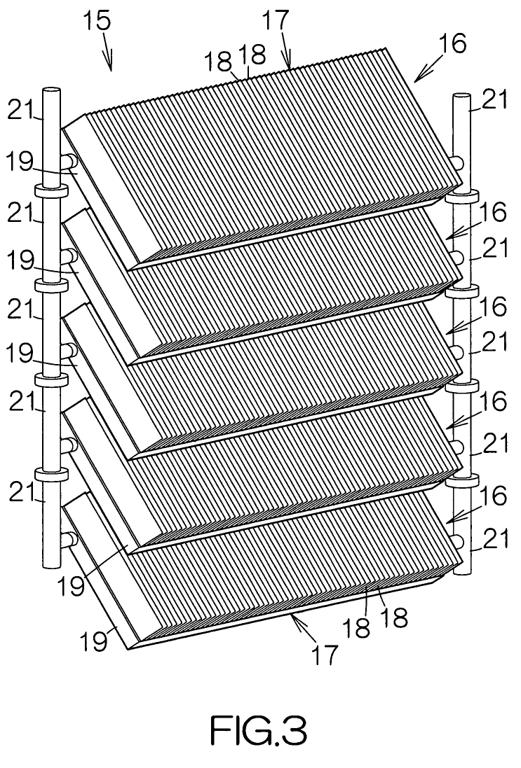

As shown in FIG. 3, the first coupling pipe 21 is connected to one end or a first side of the heat transfer plate 19 in the individual heat sink 16. The flow passage of the first coupling pipe 21 is thus connected to one end of the flow passage of the heat transfer plate 19. The second coupling pipe 21 is connected to the other end or a second side, opposite to the first side, of the heat transfer plate 19. The flow passage of the second coupling pipe 21 is thus connected to the other end of the flow passage of the heat transfer plate 19.

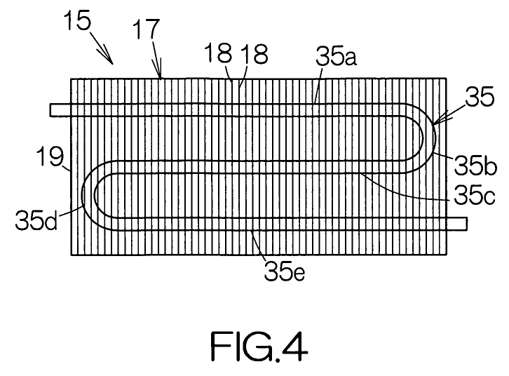

As shown in FIG. 4, a coolant flow passage 35 is defined in the heat transfer plate 19. The coolant flow passage 35 includes a first straight passage 35a, a first curved passage 35b connected to the first straight passage 35a, a second straight passage 35c connected to the first curved passage 35b, a second curved passage 35d connected to the second straight passage 35c, and a third straight passage 35e connected to the second curved passage 35d. The first, second and third straight passages 35a, 35c, 35e may extend along parallel imaginary lines. Here, the first, second and third straight passages 35a, 35c, 35e extend in parallel with one another. The flow passage 35 thus serpentines in the S-shape from one end to the other end of the heat transfer plate 19, for example.

The first straight passage 35a is connected to the flow passage of the first coupling pipe 21 in the heat sink 16. The third straight passage 35e is connected to the flow passage of the second coupling pipe 21 in the heat sink 16. A coolant may flow through the flow passage of the first coupling pipe 21, the flow passage 35 of the heat transfer plate 19, and the flow passage of the second coupling pipe 21 in this sequence. The flow passages of the first coupling pipes 21 are connected to one another. Likewise, the flow passages of the second coupling pipes 21 are connected to one another.

The CPU chip 31 generates heat during operation. The heat of the CPU chip 31 is transferred to the heat receiving plate 32. The heat receiving plate 32 serves to spread the heat over a large area. A coolant absorbs the spread heat. The coolant flows through the cooling unit 15. The coolant flows from the flow passage of the first coupling pipes 21 into the heat transfer plates 19. The heat transfer plates 19 absorb the heat from the coolant. The heat is transferred from the heat transfer plates 19 to the heat dissipating fins 18. The heat is radiated into the air from the heat dissipating fins 18 having a large surface area. The temperature of the coolant thus decreases. The coolant then flows from the second coupling pipes 21 into the tank 33.

The temperature of air increases between the heat dissipating fins 18 and between the heat sinks 16. The heated air flows upward along the heat insulating board 25 from a space behind the cooling unit 15. The heated air is discharged out of the enclosure 12 through the air outlet 14. Simultaneously, expansion of air occurs between the heat dissipating fins 18 and between the heat sinks 16 in response to an increase in the temperature of air. The air density thus decreases. The light air flows upward. Air is sucked into a space between the heat dissipating fins 18 and into a space between the heat sinks 16. A natural convention occurs. Fresh air is thus introduced through the air inlet 13. An increase in the temperature of the CPU chip 31 is in this manner effectively suppressed.

The tip ends of the heat dissipating fins 18 are opposed to the back surface of the heat transfer plate 19 of the heat sink 16 located right above at a predetermined interval in the server computer apparatus 11. The heated air thus concentrates on the individual heat sink 16. A difference in temperature increases between the heat sinks 16 and the outside of the enclosure 12. A so-called chimney effect is realized. The heat is efficiently radiated into the atmosphere from the heat dissipating fins 18. Efficiency of heat dissipation is enhanced. Even though the surface area of the heat dissipating fins 18 is reduced, the heat dissipating fins 18 enjoys the same effectiveness as the conventional heat dissipating fins achieves. Accordingly, the size of the heat dissipating fins 18, namely the cooling unit 15, can be reduced. A space for the cooling unit 15 can be significantly reduced in the enclosure 12.

The tip ends of the heat dissipating fins 18 are arranged along the imaginary inclined plane 24 intersecting the vertical plane by the predetermined angle α. Air flows from the front side to the back side of the cooling unit 15 based on the “chimney effect”. Air flows upward in the vertical direction along the heat insulating board 25 behind the cooling unit 15 in response to an increase in the temperature of air. The heated air is thus prevented from flowing from the heat sink 16 at the upstream position to the heat sink 16 at the downstream position. The heat is thus radiated from all the heat sinks 16 with uniform efficiency.

The heat sinks 16 are coupled to one another through the first and second coupling pipes 21. The first and second coupling pipes 21 can be separated from one another in a relatively facilitated manner. The cooling unit 15 is thus disassembled in a relatively facilitated manner. Accordingly, it is possible to adjust the number of the heat sinks 16 depending on a required cooling performance in a relatively facilitated manner. The size of the cooling unit 15 is determined depending on a required cooling performance.

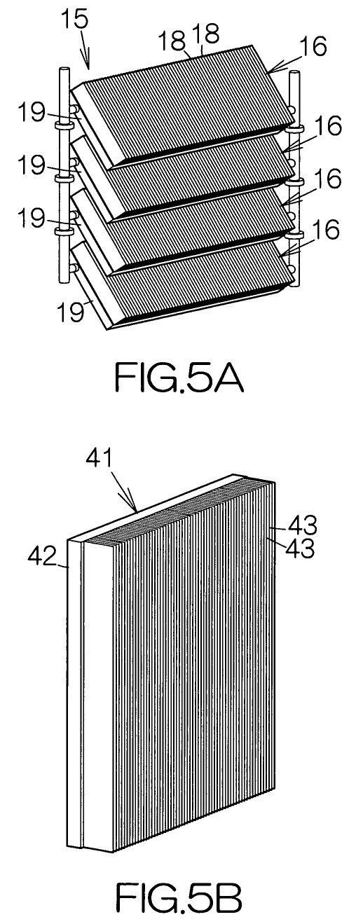

The present inventors have observed the effect of the cooling unit 15. An analysis simulation was employed for the observation. A specific example and a comparative example were prepared. As shown in FIG. 5A, an analysis model of the aforementioned cooling unit 15 was established as the specific example. It should be noted that the four heat sinks 16 were incorporated in the analysis model.

As shown in FIG. 5B, an analysis model of a cooling unit 41 was established as the comparative example. The cooling unit 41 includes a heat transfer plate 42 standing upright in the vertical direction and heat dissipating fins 43 standing upright from the surface of the heat transfer plate 42. The heat dissipating fins 43 extend in parallel with one another. An air passage is defined between adjacent ones of the heat dissipating fins 43.

The total surface area of the heat dissipating fins 18 according to the specific example was half that of the heat dissipating fins 43 according to the comparative example. The weight of the cooling unit 15 according to the specific example was set at 75% approximately of that of the cooling unit 41 according to the comparative example. The surrounding temperature was set at 35 degrees Celsius. The total amount of heat dissipation was set at 100 W in both the cooling unit 15 according to the specific example and the cooling unit 41 according to the comparative example. Under such conditions, cooling performance was analyzed in the specific example and the comparative example.

The maximum temperature of 56.5 degrees Celsius was measured in both the heat transfer plate 19 according to the specific example and the heat transfer plate 42 according the comparative example. It has been demonstrated that the amount of the radiated heat is equivalent between the specific example and the comparative example. It has also been demonstrated that the specific example is twice as efficient in heat dissipation as the comparative example because the total surface area of the heat dissipating fins 18 according to the specific example was half that of the heat dissipating fins 43 according to the comparative example.

Since the specific example employed the heat sinks 16, a uniform temperature boundary layer was established at a position adjacent to the individual heat sink 16. The thickness of the temperature boundary layer was set smaller as compared with that of a temperature boundary layer in the comparative example employing the single heat transfer plate 42. It has been demonstrated that the cooling unit 15 according to the specific example achieves heat dissipation with an enhanced efficiency as compared with the cooling unit 41 according to the comparative example.

It has been observed that a vertical airflow of a fast current runs behind the cooling unit 15 in the specific example. It has been observed that the heat sink 16 at the downstream position is not affected by the airflow from the heat sink 15 at the upstream position. It has been observed that a vertical airflow runs from the lower end to the upper end of the heat transfer plate 42 in the comparative example, for example. The heated air at the upstream position flows upward to the downstream position. The heated air hinders heat from being radiated from the heat dissipating fins 43 at the downstream position.

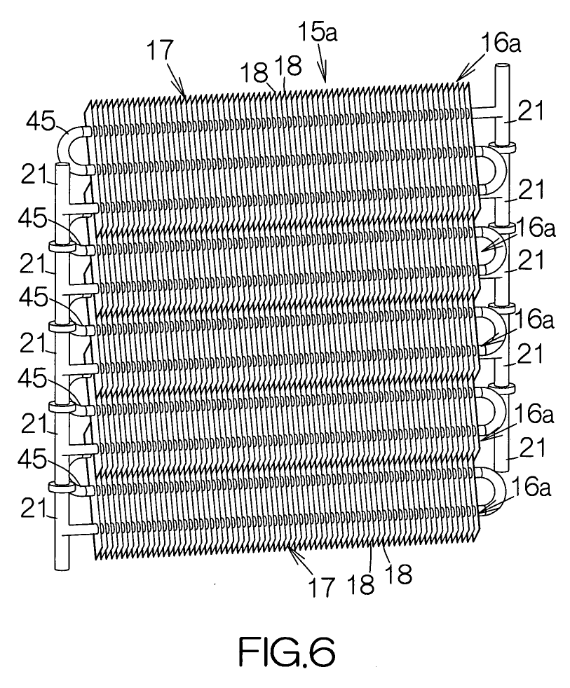

As shown in FIG. 6, a cooling unit 15a may be incorporated in the enclosure 12 of the server computer apparatus 11 in place of the aforementioned cooling unit 15. The cooling unit 15a includes five heat sinks 16a in the same manner as descried above, for example. A tube 45 as a heat conductive member is incorporated in the individual heat sink 16a in place of the aforementioned heat transfer plate 19.

The heat dissipating fins 18 are coupled to one another through the tube 45. A coolant flow passage is defined in the tube 45. The tube 45 may serpentine in the S-shape from one end to the other end of the heat dissipating fin member 17, for example. The tube 45 is made of a metallic material such as aluminum, for example. The first coupling pipe 21 is connected to one end of the flow passage of the tube 45. The second coupling pipe 21 is connected to the other end of the flow passage of the tube 45. A coolant is thus allowed to flow through the first coupling pipe 21, the tube 45 and the second coupling pipe 21 in this sequence.

The tip or upper ends of the heat dissipating fins 18 are opposed to the lower ends of the heat dissipating fins 18 of the heat sink 16a located right above at a predetermined interval. The upper ends of the heat dissipating fins 18 are arranged along an imaginary inclined plane intersecting the vertical plane by a predetermined angle α in the same manner as described above. The upper ends of the heat dissipating fins 18 and the lower ends of the heat dissipating fins 18 may be distanced from each other at a constant interval. Like reference numerals are attached to the structure or components equivalent to those of the aforementioned cooling unit 15.

The upper ends of the heat dissipating fins 18 are opposed to the lower ends of the heat dissipating fins 18 of the heat sink 16a located right above at a constant interval in the cooling unit 15a. The “chimney effect” is realized in the individual heat sink 16a. The heat is efficiently radiated into the air from the heat dissipating fins 18. Efficiency of heat dissipation is further enhanced. The cooling unit 15a is allowed to enjoy a reduction in size. The cooling unit 15a is allowed to enjoy the advantages identical to those obtained in the aforementioned cooling unit 15.

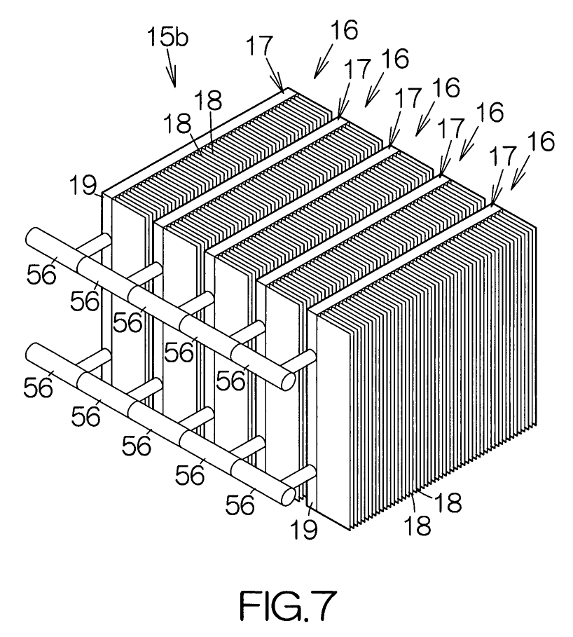

As shown in FIG. 7, a cooling unit 15b may be incorporated in the enclosure 12 of the server computer apparatus 11 in place of the aforementioned cooling units 15, 15a. The cooling unit 15b includes five heat sinks 16. The heat sinks 16 are arranged in the horizontal direction. The heat transfer plates 19 stand upright in the vertical direction. An air passage is defined in the vertical direction between adjacent ones of the heat dissipating fins 18. Here, both the ends of a coolant flow passage within the individual heat transfer plate 19 are defined in one end of the heat transfer plate 19.

One end of the flow passage in the individual heat transfer plate 19 is connected to a first coupling pipe 56. Likewise, the other end of the flow passage in the heat transfer plate 19 is connected to a second coupling pipe 56. The individual coupling pipe 56 defines a coolant flow passage. A coolant is thus allowed to flow through the first coupling pipes 56, the heat transfer plates 19 and the second coupling pipes 56 in this sequence. The first and second coupling pipes 56 are connected to one another, respectively. The flow passages of the first and second coupling pipes 56 are thus connected to one another.

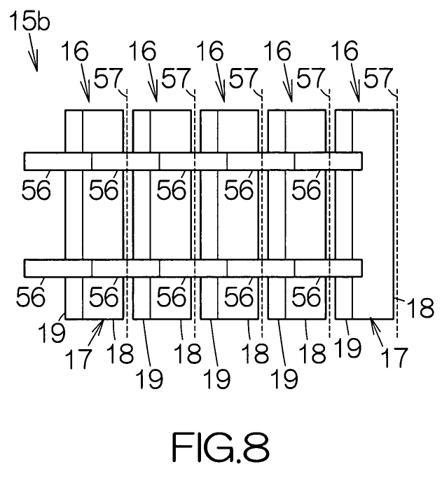

As shown in FIG. 8, the tip ends of the heat dissipating fins 18 of the individual heat sink 16 are arranged along an imaginary vertical plane 57 extending in the vertical direction. The tip ends of the heat dissipating fins 18 are opposed to the back surface of the heat transfer plate 19 of the adjacent heat sink 16. The tip ends of the heat dissipating fins 18 may be distanced from the back surface of the heat transfer plate 19 at a constant interval. Like reference numerals are attached to the structure or components equivalent to those of the aforementioned cooling units 15, 15a.

The tip ends of the heat dissipating fins 18 are opposed to the back surface of the heat transfer plate 19 of the adjacent heat sink 16 at a constant interval in the cooling unit 15b. The “chimney effect” is realized in the individual heat sink 16. A vertical airflow is generated in the cooling unit 15b. The heat is efficiently radiated into the air from the heat dissipating fins 18. Efficiency of heat dissipation is further enhanced. The cooling unit 15b is allowed to enjoy a reduction in size. The cooling unit 15b is allowed to enjoy the advantages identical to those obtained in the aforementioned cooling units 15, 15a. It should be noted that the cooling unit 15b is preferably opposed to an air inlet formed below the cooling unit 15b.

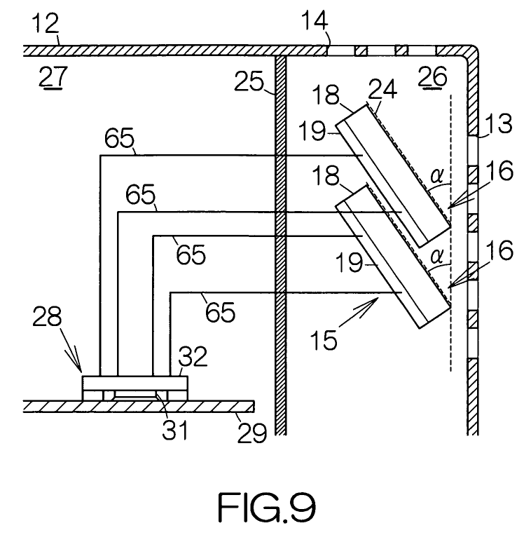

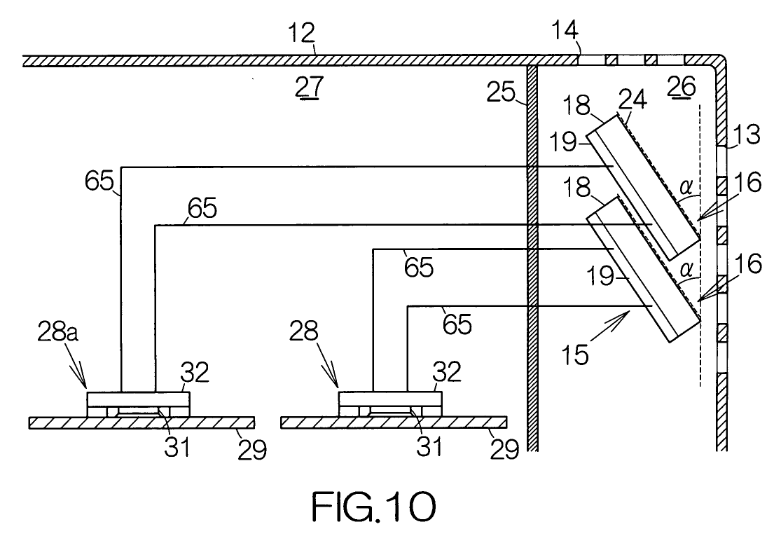

As shown in FIG. 9, heat pipes 65 may be utilized to connect the aforementioned cooling unit 15 to the heat receiving plate 32. Here, the two heat pipes 65, 65 may extend between the heat receiving plate 32 and the individual heat sink 16. The heat pipes 65 may include a tube made of a metallic material such as copper, for example, containing a coolant sealed therein. In this manner, an air cooling unit may be established based on the combination of the heat sink 15 and the heat receiving plate 32.

The heat pipes 65 may extend within the heat transfer plate 19 in place of the coolant flow passage. Likewise, the heat pipes 65 may extend within the heat receiving plate 32 in place of the coolant flow passage. Like reference numerals are attached to the structure or components equivalent to the aforementioned ones. The cooling unit 15 of this type is allowed to enjoy the advantages identical to those obtained in the aforementioned cooling unit 15.

In the case where two motherboards 28, 28a are incorporated in the enclosure 12 as shown in FIG. 9, the motherboards 28, 28a may be connected to the corresponding heat sinks 16, respectively. The two heat pipes 65, 65 may extend between the heat receiving plate 32 and the corresponding heat sink 16. Like reference numerals are attached to the structure or components equivalent to the aforementioned ones. The cooling unit 15 of this type is allowed to enjoy the advantages identical to those obtained in the aforementioned cooling unit 15.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification related to a showing of the superiority and inferiority of the invention. Although the embodiments of the present inventions have been described in detail, it should be understood that the various changes, substitutions and alterations could be made hereto without departing from the spirit and scope of the invention.

What is claimed is:

1. A cooling unit comprising:
a first heat dissipating fin member including first heat dissipating fins extending along parallel planes, respectively, the first heat dissipating fins coupled to one another through a first heat conductive member; and
a second heat dissipating fin member including second heat dissipating fins extending along parallel planes, respectively, the second heat dissipating fins coupled to one another through a second heat conductive member, tip ends of the second heat dissipating fins opposed to the first heat dissipating fin member at a predetermined interval.

2. The cooling unit according to claim 1, wherein the tip ends of the second heat dissipating fins are arranged along an imaginary inclined plane intersecting a vertical direction by a predetermined angle.

3. The cooling unit according to claim 2, wherein the tip ends of the second heat dissipating fins are opposed to the first heat dissipating fin member at a constant interval.

4. The cooling unit according to claim 1, wherein the tip ends of the second heat dissipating fins are arranged along an imaginary vertical plane extending in a vertical direction.

5. The cooling unit according to claim 4, wherein the tip ends of the second heat dissipating fins are opposed to the first heat dissipating fin member at a constant interval.

6. The cooling unit according to claim 1, further comprising:
a pair of first coupling members fixed to the first heat dissipating fin member, the first coupling members extending along parallel imaginary lines, respectively; and
second coupling members fixed to the second heat dissipating fin member, the second coupling members extending along parallel imaginary lines, respectively, the second coupling members respectively coupled to the first coupling members.

7. The cooling unit according to claim 1, further comprising:
a first coolant flow passage defined in the first heat conductive member;
a first coupling member defining a second coolant flow passage connected to one end of the first coolant flow passage;
a second coupling member extending along an imaginary line parallel to the first coupling member, the second coupling member defining a third coolant flow passage connected to an other end of the first coolant flow passage;
a fourth coolant flow passage defined in the second heat conductive member;
a third coupling member received on the first coupling member, the third coupling member defining a fifth coolant flow passage connected to one end of the fourth coolant flow passage and the second coolant flow passage; and
a fourth coupling member received on the second coupling member, the fourth coupling member extending along an imaginary line parallel to the third coupling member, the fourth coupling member defining a sixth coolant flow passage connected to an other end of the fourth coolant flow passage and the third coolant flow passage.

8. A heat sink comprising:
a heat dissipating fin member including heat dissipating fins extending along parallel planes, respectively, the heat dissipating fins coupled to one another through a heat conductive member; and
a pair of coupling members fixed to the heat dissipating fin member, the coupling members extending along parallel lines.

9. An electronic apparatus comprising:
an enclosure;
a first heat dissipating fin member located in the enclosure, the first heat dissipating fin member including first heat dissipating fins extending along parallel planes, respectively, the first heat dissipating fins coupled to one another through a first heat conductive member; and
a second heat dissipating fin member including second heat dissipating fins extending along parallel planes, respectively, the second heat dissipating fins coupled to one another through a second heat conductive member, tip ends of the second heat dissipating fins opposed to the first heat dissipating fin member at a predetermined interval.

10. The electronic apparatus according to claim 9, further comprising:
an electronic component located in the enclosure, the electronic component generating heat transferred to the first and second heat conductive members; and
a heat insulating member located in the enclosure between the electronic component and the first heat dissipating fin member and between the electronic component and the second heat dissipating fin member.

11. The electronic apparatus according to claim 9, wherein the tip ends of the second heat dissipating fins are arranged along an imaginary inclined plane intersecting a vertical direction by a predetermined angle.

12. The electronic apparatus according to claim 11, wherein the tip ends of the second heat dissipating fins are opposed to the first heat dissipating fin member at a constant interval.

13. The electronic apparatus according to claim 9, wherein the tip ends of the second heat dissipating fins are arranged along an imaginary vertical plane extending in a vertical direction.

14. The electronic apparatus according to claim 13, wherein the tip ends of the second heat dissipating fins are opposed to the first heat dissipating fin member at a constant interval.

15. The electronic apparatus according to claim 9, further comprising:
a pair of first coupling members fixed to the first heat dissipating fin member, the first coupling members extending along parallel imaginary lines, respectively; and
second coupling members fixed to the second heat dissipating fin member, the second coupling members extending along parallel imaginary lines, respectively, the second coupling members respectively coupled to the first coupling members.

16. The electronic apparatus according to claim 9, further comprising:
a first coolant flow passage defined within the first heat conductive member;
a first coupling member defining a second coolant flow passage connected to one end of the first coolant flow passage;
a second coupling member extending along an imaginary line parallel to the first coupling member, the second coupling member defining a third coolant flow passage connected to an other end of the first coolant flow passage;
a fourth coolant flow passage defined in the second heat conductive member;
a third coupling member received on the first coupling member, the third coupling member defining a fifth coolant flow passage connected to one end of the fourth coolant flow passage and the second coolant flow passage; and
a fourth coupling member received on the second coupling member, the fourth coupling member extending along an imaginary line parallel to the third coupling member, the fourth coupling member defining a sixth coolant flow passage connected to an other end of the fourth coolant flow passage and the third coolant flow passage.
